(19) United States
(12) Patent Application Publication
(10) Pub. No.: US 2026/0156673 A1
(43) Pub. Date: Jun. 4, 2026

(54) NPCA PRIMARY CHANNEL CHANGE ANNOUNCEMENT

(71) Applicant: Cisco Technology, Inc., San Jose, CA (US)

(72) Inventors: Binita GUPTA, San Diego, CA (US); Brian D. HART, Sunnyvale, CA (US); Malcolm M. SMITH, Richardson, TX (US)

(21) Appl. No.: 19/454,633

(22) Filed: Jan. 21, 2026

Related U.S. Application Data
(63) Continuation of application No. 19/367,795, filed on Oct. 23, 2025.
Application No. 19/367,795 is a continuation-in-part of application No. 19/281,568, filed on Jul. 26, 2025, now abandoned.
(60) Provisional application No. 63/712,338, filed on Oct. 25, 2024.

(51) Int. Cl. H04W 74/00

(52) U.S. Cl. CPC H04W 74/002

(57) ABSTRACT

An AP may want to change the non-primary channel access (NPCA) primary channel (NPCH) when the primary channel for the BSS is unavailable, e.g., due to interference on the current NPCH or as a result of RRM. The embodiments herein describe techniques to coordinate the NPCH change and announce it in advance so that both the access point (AP) and stations (STAs) start using the new NPCH at the same time. That is, the embodiments herein describe mechanisms where both the AP and associated STAs start using the new NPCH at the same time when the NPCH changes.

### CROSS-REFERENCE TO RELATED APPLICATIONS

This application is a continuation of co-pending U.S. patent application Ser. No. 19/367,795 filed Oct. 23, 2025, which is a continuation-in-part of U.S. patent application Ser. No. 19/281,568, filed Jul. 26, 2025, which is now abandoned and which claims benefit of U.S. provisional patent application Ser. No. 63/712,338 filed Oct. 25, 2024. The aforementioned related patent applications are herein incorporated by reference in their entirety.

### TECHNICAL FIELD

Embodiments presented in this disclosure generally relate to Non-primary Channel Access (NPCA) primary channel change announcements.

### BACKGROUND

NPCA is a mechanism for efficient use of an access point's (AP's) operating bandwidth (BW). With NPCA, when an overlapping Basic Service Set (OBSS) transmission is detected on the primary channel, both the AP and station (STA) switch to a secondary/non-primary channel for transmission, which is referred to as the NPCA primary channel (NPCH).

For NPCA operation, the AP advertises the NPCH and the NPCA channel BW in the basic service set (BSS). Both the AP and STA switch to the NPCH if an OBSS transmission is detected on the primary channel in the BSS. Both the AP and STA also exchange their NPCH switching delay to a peer STA, and the peer STA would honor that delay and not initiate transmit opportunities (TXOPs) on the NPCH before that switching delay.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a wireless network that changes a primary channel for NPCA, according to one embodiment.

FIG. 2 is a flowchart for changing a primary channel for NPCA, according to one embodiment.

FIG. 3 illustrates a frame for an announcement that changes a primary channel for NPCA, according to one embodiment.

FIG. 4 illustrates a frame for an announcement that changes a primary channel for NPCA, according to one embodiment.

FIG. 5 is a flowchart for changing a primary channel for NPCA when performing dynamic bandwidth expansion, according to one embodiment.

FIG. 6 depicts an example computing device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is an AP that includes one or more memories and one or more processors communicatively coupled to the one or more memories, wherein the one or more processors are configured to, individually or collectively, perform operations for changing a primary channel used during NPCA. The operations include transmitting a first wireless message indicating the NPCA primary channel (NPCH) and transmitting a second message announcing a change to the NPCH, the second message comprises a new NPCH and a switch time. Moreover, the switch time indicates a future time when the new NPCH should be used when performing NPCA.

Another embodiment presented in this disclosure is a method that includes changing a primary channel used during NPCA. The method further includes transmitting, from an AP, a first wireless message indicating the NPCH and transmitting, from the AP, a second message announcing a change to the NPCH, the second message comprises a new NPCH and a switch time. Moreover, the switch time indicates a future time when the new NPCH should be used when performing NPCA.

Another embodiment presented in this disclosure is a non-transitory computer-readable medium that contains, in any combination, computer program code, which, when executed by one or more processors, performs operations. The operations include transmitting, from an access point (AP), a first wireless message indicating an NPCH and transmitting, from the AP, a second message announcing a change to the NPCH, the second message comprises a new NPCH and a switch time. Moreover, the switch time indicates a future time when the new NPCH should be used when performing NPCA.

### EXAMPLE EMBODIMENTS

An AP may want to change the NPCH used to perform NPCA when the primary channel for the BSS is unavailable. For example, the current NPCH may have interference or because a bandwidth (BW) allocation has changed (e.g. based on radio resource management (RRM)). The embodiments herein describe techniques to coordinate the NPCH change and announce it in advance so that both the AP and STA start using the new NPCH at the same time. Without careful coordination, changes to NPCH may lead to disruption in NPCA operation, where the AP may start using the new NPCH but the STA is still operating using the old NPCH (e.g., which can happen when STAs come out of power save and perform NPCA but the AP has changed the NPCH). Such NPCH switch would be a waste and lead to suboptimal NPCA operation impacting overall BSS performance. The embodiments herein describe mechanisms where both the AP and STAs start using the new NPCH at the same time when the NPCH changes.

In one embodiment, the AP announces changes to the NPCH in advance in one or more of Beacon, Probe Response or other management frames in the BSS. In one embodiment, the NPCH switch announcement mechanism can be defined similar to the existing (Extended) Channel Switch Announcement (CSA) mechanism. In any case, the announcement containing the NPCH can include the new primary channel (e.g., a new channel number) and a switch time when the AP and STA will begin to use the primary channel. This announcement can contain other information such as channel switch mode (e.g., whether the current NPCH can still be used until the switch occurs), punctured channels, channel width of the NPCH, the center frequency of the NPCH, operating class (or multiple operating classes), or a duration of the channel switch.

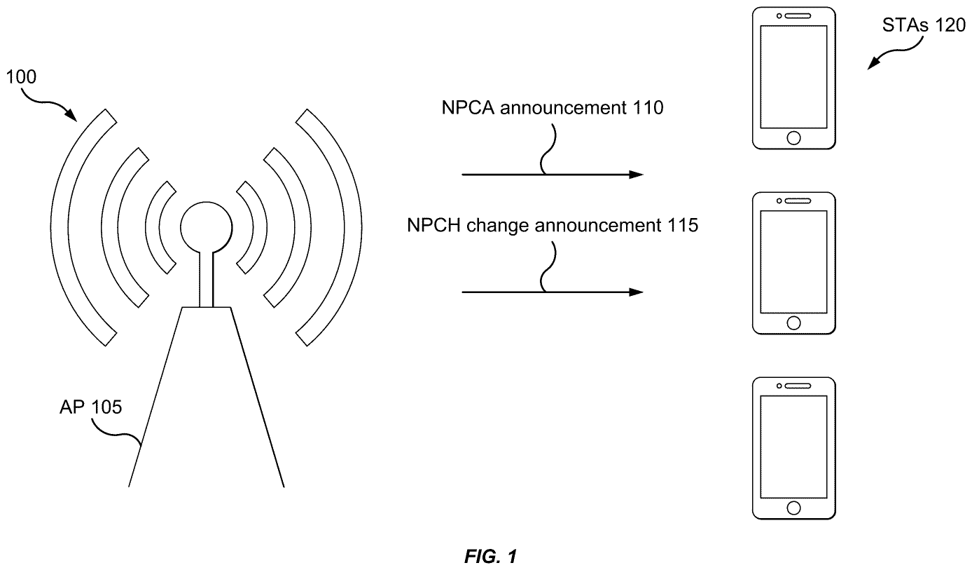

FIG. 1 illustrates a wireless network 100 that changes a primary channel for NPCA, according to one embodiment. FIG. 1 illustrates an AP 105 and several STAs 120 (e.g., mobile phones, tablets, laptops, desktop computers, etc.). It is assumed that the STAs 120 have already associated with the AP 105.

A BSS is a fundamental building block of a wireless local area network (WLAN), including an AP and one or more wireless client stations like laptops and smartphones. The primary channel in the BSS is the main frequency segment (e.g., typically 20 MHz) on which a Wi-Fi AP operates and within which all devices in the BSS contend for channel access. However, OBSS refers to the situation where multiple Wi-Fi networks (or BSSs) are operating on the same or overlapping channels. This can lead to interference and degraded performance. As mentioned above, NPCA provides a secondary/non-primary channel (i.e., the NPCH) that the AP and a STA can use when an OBSS transmission is detected on the primary channel of the BSS. The AP and STA can then use the NPCH to perform the functions that would normally be performed on the primary channel of the BSS (e.g., clear channel assessment (CCA)).

FIG. 1 illustrates the AP 105 transmitting an NPCA announcement 110 that informs the STAs 120 of the NPCH that should be used if an OBSS transmission is detected on the primary channel of the BSS. That is, the AP 105 can advertise the NPCH before there is any problem detected on the primary channel of the BSS. Then, when an OBSS transmission is detected on the primary channel, the AP 105 and the STAs 120 can use the NPCH indicated in the NPCA announcement 110 to contend for wireless resources—i.e., the NPCH can be used as the primary channel of the BSS.

However, for any number of reasons, the AP 105 may want to change the NPCH. This can be because the current NPCH is experiencing interference, changes to RRM, or because the BW of the AP 105 is expanding/shrinking. Whatever the reason, the AP 105 transmits an NPCH change announcement 115 to the STAs. This announcement 115 (e.g., a management frame) can include the new channel number of the NPCH as well as a switch time (e.g., a future time) indicating when the new channel should be used to perform NPCH. Advantageously, by having a switch time, this coordinates the AP 105 and the STAs 120 so they start using the new NPCH at the same time. This avoids the AP and STAs 120 potentially using a different NPCH, which can lead to suboptimal NPCA operation.

As discussed in more detail below, the NPCH change announcement 115 can include other information in addition to the new NPCH and the switch time. The NPCH change announcement 115 can include other NPCA parameters such as NPCA switching delays for the new NPCH channel or OBSS PPDU duration threshold for NPCA (e.g., defines minimum OBSS PPDU duration when NPCA should be used). The announcement 115 can also include parameters such as a channel switch mode (e.g., which indicates whether the current NPCH can still be used for NPCA until the switch occurs to the new NPCH), set of punctured sub channels when operating using the new NPCH, channel width for NPCA operation with the new NPCH, the center frequency of the channel width used for NPCA operation on new NPCH, operating class corresponding to the new NPCH (or multiple operating classes), or a duration for which the NPCH channel change is effective. If multiple operating classes are indicated, then the announcement 115 can include a list of tuples of (operating class+associated new NPCH for that operating class). Moreover, the NPCH change announcement 115 may be treated as a critical update notification or announcement, and can be included in a management frame of the BSS, such as a beacon, probe response, or an Extended Channel Switch Announcement (E-CSA). When the NPCH change announcement 115 is considered a critical update announcement, then the AP can send out the announcement 115 in advance in a beacon probe response for multiple beacon intervals to announce that a critical update change is coming to the NPCH and other NPCA parameters. This NPCH critical update change may update/increment any counters maintained and advertised by the AP to signal critical updates for the BSS. For example, this NPCH change can increment a BSS parameters change count (BPCC) field that is incremented when there is a critical update to any BSS parameters. The BPCC field can be defined for specific generations such as EHT and/or UHR. If a separate BPCC is defined for UHR, then the NPCH change would increment BPCC for UHR. The NPCH change can also increment a common change counter that is maintained for critical updates across each affiliated AP of an AP multi-link device (MLD). In case of a multiple BSSID set (where multiple BSSIDs mapped to different SSIDs share common radio resources), a common change counter may be maintained across each BSSID of the multiple BSSID set. In this case, the NPCH change would also increment the common change counter maintained across the BSSIDs of a multiple BSSID (MBSSID) set.

Moreover, while FIG. 1 illustrates one NPCH change announcement 115, the AP 105 may change the NPCH multiple times. For example, the AP 105 may change the NPCH when its BW expands or interference is detected on the current NPCH using a first NPCH change announcement, but then change the NPCH back to the previous channel after its BW shrinks or the interference disappears.

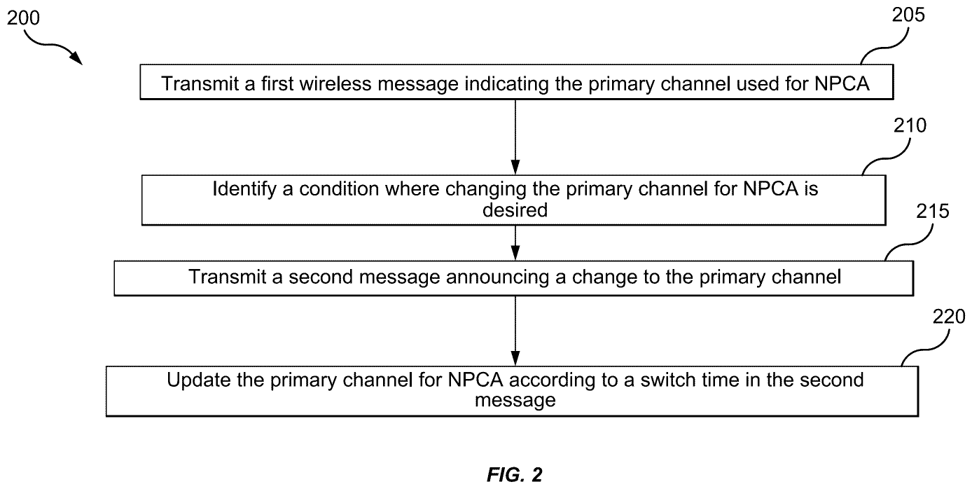

FIG. 2 is a flowchart of a method 200 for changing an NPCH for NPCA, according to one embodiment. At block 205, the AP transmits a first wireless message indicating the primary channel (i.e., NPCH) used for NPCA. This first message (e.g., the NPCA announcement 110 in FIG. 1) informs the STAs of the NPCH that should be used if an OBSS transmission is detected on the primary channel of the BSS. The first message can advertise the NPCH before there is any problem detected on the primary channel of the BSS. Then, when an OBSS transmission is detected on the primary channel, the AP and the STAs can use the NPCH indicated in the first message to contend for wireless resources—i.e., the NPCH can be used as the primary channel of the BSS.

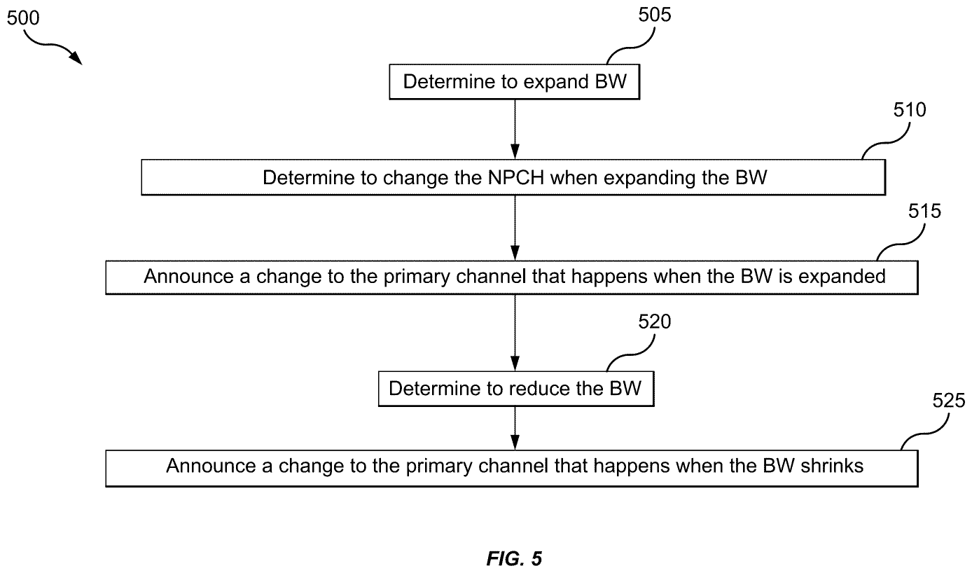

At block 210, the AP identifies a condition where changing the primary channel for NPCA is desired. For example, the current NPCH may have interference, or due to changes made as part of RRM. In another example, the AP may change the NPCH when a BW of the AP is expanding or shrinking as part of dynamic bandwidth expansion (DBE). The interaction between NPCH change announcements and DBE is discussed in more detail in FIG. 5.

Moreover, while the AP can detect a condition where changing the NPCH is desired, in another embodiment, one of the STAs may detect a problem or issue with the current NPCH and then inform the AP. For example, a STA may send a request to the AP to change the NPCH, and may indicate the issue with the current NPCH. The AP can then decide whether or not to change the NPCH.

At block 215, the AP transmits a second message announcing a change the primary channel. The second message (e.g., the NPCH change announcement 115 in FIG. 1) can indicate the new channel for the NPCH as well as the switch time when the STAs should begin to use the new NPCH to perform NPCA. That is, before the switch time, the STAs should not use the new NPCH and may use the current NPCH to perform NPCA. However, in other embodiments, the AP may decide the STAs should not use the current NPCH either, which can be indicated in the second message. In that case, NPCA may effectively be disabled in the network until the switch time has expired and the new NPCH is available for use.

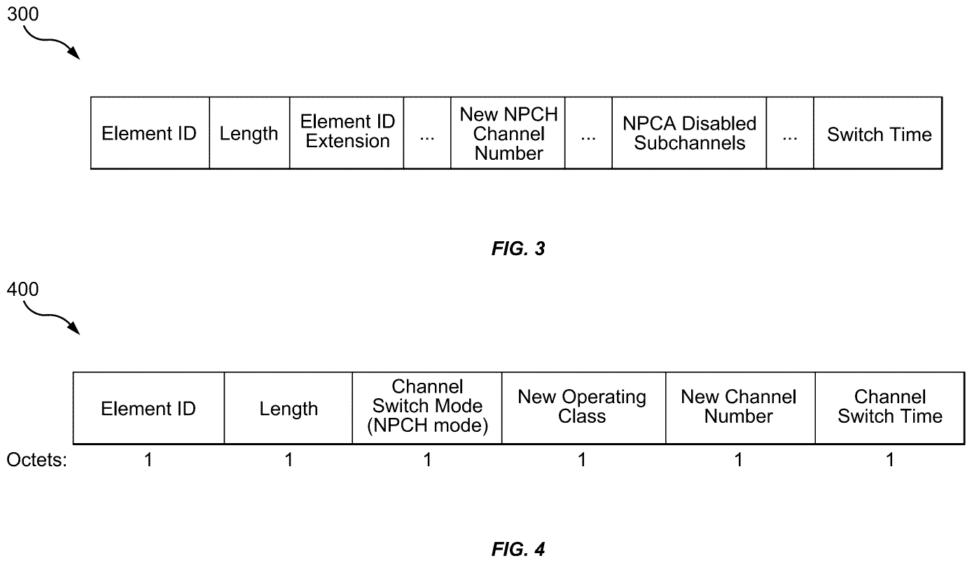

In one embodiment, the second message is (or part of) a management frame, and can be a critical update in the BSS. FIGS. 3 and 4 describe different implementations of a message for changing the NPCH for NPCA.

FIG. 3 illustrates an element 300 that provides information for NPCH channel change announcement in a frame (e.g. a beacon or probe response) for an announcement that changes a primary channel for NPCA. In one embodiment, the element 300 is a new element used for a critical update announcement for BSS parameters. This element can also be used for an NPCH change announcement. In another embodiment, the element 300 can be a new element defined for an NPCH change announcement. The AP advertises this new element for NPCH change which includes a New NPCH Channel Number providing a channel number for the new NPCH and a switch time indicating when the new NPCH will become effective. In one case the element 300 can include a NPCA Disabled Subchannels field providing a set of subchannels that are disabled for NPCA when using new NPCH. In one case, the new element can additionally include a channel switch mode and/or new operating class corresponding to the new NPCH channel number (these fields are not shown in FIG. 3).

In one example, the channel switch mode indicates whether to continue using NPCA for the remaining time duration using the current NPCH, before switching to new NPCH. For example, one value (e.g., one) may indicate that the NPCA operation should not be performed on the currently advertised (or any) NPCH until the switch happens to the new NPCH channel number according to the switch time in the element. In contrast, if the channel switch mode is set to a different value (e.g., zero) this indicates that NPCA operation can continue on the currently advertised NPCH.

In one embodiment, the channel switch count in the NCSA element 300 indicates the number of target beacon transmission times (TBTTs) until the AP switches to using the new NPCH channel number indicated in the element 300. For example, a channel switch time=1 in a Beacon (or another frame) indicates that the NPCH switch occurs before (or right after) the next TBTT. A channel switch time=0 in a Beacon (or another frame) indicates that the NPCH switch occurs right after that frame. In that case, both the AP and the STA start using the new NPCH right after the received frame.

Alternatively, the AP can indicate the time when the new NPCH channel switch happens by explicitly indicating an NPCH channel switch start time relative to the AP's timing synchronization function (TSF) (e.g. in time units (TUs)). Both the AP and STA start using the new NPCH at the NPCH channel switch time indicated in the element 300.

In one embodiment, an NPCA bandwidth indication element, which can be styled after an existing Bandwidth Indication element but with a new element ID and/or element ID extension, can be included to indicate channel width, channel center frequency, and any punctured sub-channels for the new NPCH. Alternatively, an existing bandwidth indication element can be adapted, e.g., one of the reserved bits in the bandwidth indication parameters can indicate that the Bandwidth Indication element is repurposed and now signals the ‘NPCA Primary Channel’ and not the regular primary channel of the BSS. Alternatively, the bandwidth indication element can be sent as a sub-element of the new element 300 used for NPCH channel switch announcement, and/or the extra contents of the bandwidth indication element (e.g., channel width, center frequency, and puncturing-related information to be used for a new NPCH) can be appended to the element 300 shown in FIG. 3.

In one embodiment, to handle new operating classes yet to be defined or bandwidths yet to be defined, the NPCH channel switch announcement element 300 can include multiple tuples that list additional information for new operating classes. For example, the element can have a list that includes the operating class, plus channel number, plus channel width, plus puncturing information, plus center frequency. In one embodiment, the NPCH channel switch announcement element 300 can have a list of different operating classes, where some are for legacy devices (which do not understand or are not aware of the new operating classes) and others are new operating classes which are understood by newer STAs. For example, the NPCH channel switch announcement element 300 can include a channel list length field (e.g., 1 octet) and then a channel list length indicating a number of duples, where each duple includes a new operating class and a new channel number (and optionally a channel width, puncturing information, center frequency, etc.).

The recipient STA can select from among the duples understood by the STA (e.g., chooses from the known duples the duple with the most number of un-punctured 20 MHz sub-channels). In another embodiment, each new duple can be sent at the end of the NPCH channel switch announcement element 300 (after encapsulation) as a new sub-element.

In one embodiment, a beacon, probe response or another management frame includes both the NPCH channel switch announcement element 300 and (if present) the NPCA/modified bandwidth indication element (or another equivalent element) to indicate information for the new NPCH.

FIG. 4 illustrates using an E-CSA element 400 for an announcement that changes a primary channel for NPCA, according to one embodiment. In this example, the AP uses the E-CSA element 400 to announce an NPCH switch. To do so, the AP may use a specific value in the Channel Switch Mode field to indicate that the E-CSA element 400 is for an NPCH switch (rather than for its original purpose)—e.g., a NPCH mode. For example value 255 (or another value) can indicate that E-CSA element 400 is being used to change the NPCH—i.e., is in an NPCH mode. When the channel switch mode includes the value corresponding to an NPCH change, the new channel number field in E-CSA element stores the new NPCH channel number.

Similar to discussed in FIG. 3, (a) a modified bandwidth indication element can be included to indicate channel width, channel center frequency, and any punctured sub-channels for the new NPCH where one of the reserved bit in the bandwidth indication parameters can indicate that the bandwidth indication element is for the NPCA Primary Channel and not the regular primary channel used in E-CSA, (b) or the bandwidth indication element for NPCH is a new element, (c) or the bandwidth indication element is a sub-element of the element shown in FIG. 4, or (d) the bandwidth indication element is appended as a new fixed field after the fields listed in the E-CSA element 400, or (e) the element 400 can include a list of different operating classes (e.g., operating class, plus channel number, plus channel width, plus puncturing info, plus center frequency, etc. for each operating class), or (f) this list might be formatted as a sequence of sub-elements.

Like in FIG. 3, the channel switch time in the E-CSA element 400 can indicate the number of TBTTs or TSF until the AP switches to using the new NPCH indicated.

FIG. 5 is a flowchart of a method 500 for changing a primary channel for NPCA when performing DBE, according to one embodiment. CSA or E-CSA in IEEE 802.11 standard can support changing the operating BW of a BSS. However, using existing CSA or E-CSA to obtain more frequency or perform dynamic bandwidth change has undesirable impacts on legacy devices. For example, most legacy STAs respond to CSA/E-CSA by roaming away and then roaming back (causing double scan/roam hit). To perform BW expansion using CSA/E-CSA (e.g., every few seconds or minutes), the double roaming has a serious negative impact on the performance of the legacy STAs. In addition, some legacy STAs will not associate with an AP that supports CSA. Further, CSA/E-CSA BW changes are designed for use with RRM, which is primarily for non-real time (or longer time scale) changes to channel and BW selection, and is not expected to be used for fast/real-time/frequent BW changes (e.g., at each transmit opportunity (TXOP) level, every millisecond, every second, or every minute or every few minutes etc.). In addition, the CSA/ECSA is mainly used for changing primary channel, which is not the case for DBE (or RT-DBE), where the primary 20 MHz channel for the BSS remains the same and only BW changes. Using CSA/ECSA for only bandwidth changes may cause field interoperability issues with legacy devices.

To perform RT DBE, the AP and STAs exchange signals indicating their respective DBE capabilities (e.g., whether DBE is supported, maximum DBE dynamic BW supported, list of one or more dynamic BW supported, etc.). Later, the AP (or a network controller) can determine to perform DBE. For example, the load on the AP may jump because the AP is located in a conference room or an event center. To provide additional BW to serve higher loads, the AP (or the RRM logic or controller) can determine to perform a DBE operation which makes the wider channel BWs available to the AP, e.g., 80 MHz, 160 MHz or 320 MHz. To do so, the AP transmits a DBE announcement in advance to inform the STAs about an upcoming expanded BW. This announcement can include information of the expanded DBE bandwidth such as expanded DBE channel bandwidth, center frequency for the expanded BW, whether one or more sub-channel is punctured within the expanded BW, etc.) and indicate the start time (or the DBE BW switch time) when the BW will be expanded. The DBE BW switch time can be indicated, e.g., as the number of TBTTs till the AP switches to the DBE BW or a future TSF time when the DBE BW switch happens. The DBE announcement can be sent for certain beacon intervals in advance (before DBE BW change takes place) e.g., sent for few delivery traffic indication map (DTIM) beacon intervals or can be sent for larger number of beacon intervals based on the listen interval of associated STAs that support DBE. This enables STAs to prepare and get ready to operate at the expanded BW. In one embodiment, signaling for the advance DBE announcement can be provided as part of one or more of beacon, probe response, fast initial link setup (FILS) discovery or association or reassociation response frames.

At block 505, the AP (or a network controller) determines to expand the BW. As mentioned above, the load on the AP may jump so to provide additional BW to serve higher load, the AP (or the RRM logic or controller) can determine to perform a DBE operation which makes the wider channel BWs available to the AP, e.g., 80 MHz, 160 MHz or 320 MHz.

At block 510, the AP determines to change the NPCH when expanding the BW. For example, using a wider channel may mean that a more optimal NPCH is now available for perform NPCA. For example, a NPCH within the expanded BW may have less interference, or can be wider (e.g., have more BW).

At block 515, the AP announces a change to the primary channel that happens when the BW is expanded. That is, using any of the embodiments discussed above in FIGS. 1-4, the AP can announce a change to the NPCH that is synchronized with the change in BW. That is, the change to the NPCH can go into effect at the same time as the DBE session begins (and the BW is expanded). Put differently, the NPCH change starts at the same time as the start of the DBE session. The AP and STAs that have NPCA enabled (and where the new NPCH falls in their operating BW) start using the new NPCH at the NPCH switch time indicated in the announcement which can be the same time when the BW is expanded.

At block 520, the AP (or RRM or controller) determines to reduce the BW of the AP. For example, the increased load on the AP may have been temporary, or the BW may be needed by a neighboring AP.

At block 525, the AP announces a change to the NPCH that happens when the BW shrinks. Again, using any of the embodiments discussed above in FIGS. 1-4, the AP can announce a change to the NPCH that is synchronized with the change in BW. For example, after the DBE operation ends, the AP and STAs switch back to the previous NPCH within the AP's original operating BW. For this change, the AP can advertise another NPCH switch announcement where the NPCH switch time is the same as the end time of the DBE session. In this manner, the NPCH switch time and the expansion and reduction of the AP's BW can be synchronized.

In one embodiment, the AP can advertise that the new NPCH is valid only for a set duration and define this duration independent of the DBE announcement using NPCH CSA. The NPCH CSA can indicate both the start time and the end time for NPCH switch. When the duration expires, the AP and STAs go back to using the previous NPCH before the switch occurred.

In yet another embodiment, the AP can define a mechanism (e.g., in the announcement sent at block 515) to indicate that NPCH switch happens only for certain duration (using start time and duration/end time). The AP can define the NPCH switch to match the duration indicated in the DBE announcement (assuming the duration of the DBE session is fixed rather than being open ended). That way, the STAs know to switch back to the previous NPCH at the same time as the DBE session expires, without the AP having to send another NPCH switch announcement.

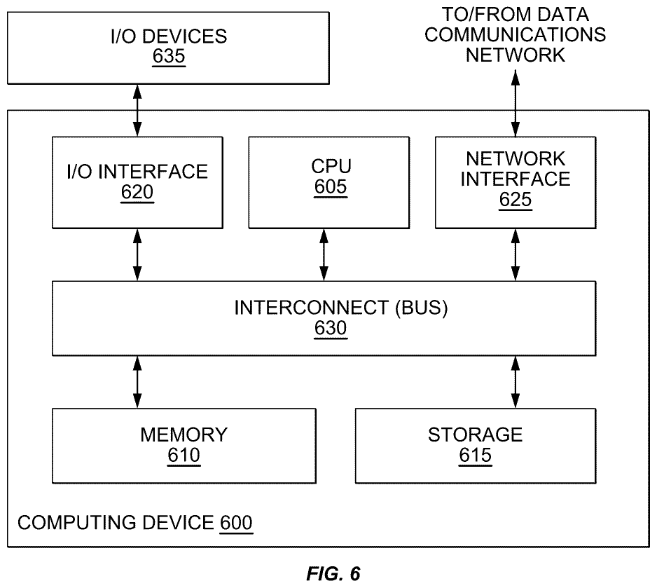

FIG. 6 depicts an example computing device configured to perform various aspects of the present disclosure, according to one embodiment. Although depicted as a physical device, in embodiments, the computing device 600 may be implemented using virtual device(s), and/or across a number of devices (e.g., in a cloud environment). In one embodiment, the computing device 600 corresponds to a network device (e.g., a computing system), such as the APs or the STAs (e.g., user devices) mentioned above.

As illustrated, the computing device 600 includes a CPU 605 (one or more processors), memory 610 (or memories), storage 615, a network interface 625, and one or more input/output (I/O) interfaces 620. In the illustrated embodiment, the CPU 605 retrieves and executes programming instructions stored in memory 610, as well as stores and retrieves application data residing in storage 615. The CPU 605 is generally representative of a single CPU and/or GPU, multiple CPUs and/or GPUs, a single CPU and/or GPU having multiple processing cores, and the like. The memory 610 is generally included to be representative of a random access memory. Storage 615 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 635 (such as keyboards, monitors, etc.) are connected via the I/O interface(s) 620. Further, via the network interface 625, the computing device 600 can be communicatively coupled with one or more other devices and components (e.g., via a network, which may include the Internet, local network(s), and the like). As illustrated, the CPU 605, memory 610, storage 615, network interface(s) 625, and I/O interface(s) 620 are communicatively coupled by one or more buses 630.

The memory 610 can include software programs or application for changing the NPCH for NPCA, and for performing DBE as discussed above in FIGS. 1-5. Although shown as residing in memory 610, in embodiments, the operations of discussed above (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

1. A method comprising
managing, by an access point, a basic service set (BSS) on a primary channel;
supporting, by the access point, a Non-Primary Channel Access (NPCA) mode of operation for the BSS using a first NPCA primary channel;
advertising, by the access point, the first NPCA primary channel to one or more wireless stations of the BSS;
determining a NPCA primary channel change time for updating the BSS from the first NPCA primary channel to a second NPCA primary channel;
prior to the NPCA primary channel change time, transmitting by the access point, a wireless management frame that announces a NPCA primary channel change, the wireless management frame including data indicating the second NPCA primary channel and the NPCA primary channel change time; and
at the NPCA primary channel change time, transitioning, by the access point, the NPCA mode of operation for the BSS to use the second NPCA primary channel.

2. The method of claim 1 wherein the data indicating the NPCA primary channel change time is a number of target beacon transmission times until the NPCA primary channel change time.

3. The method of claim 1 further comprising:
determining to switch from the first NPCA primary channel to the second NPCA primary channel based on detected interference on the first NPCA primary channel.

4. The method of claim 1 wherein the wireless management frame is a beacon frame, a probe response frame or a (re)association response frame.

5. The method of claim 1 further comprising:
transmitting, after the NPCA primary channel change time, one or more additional management frames including data indicating the second NPCA primary channel.

6. The method of claim 1 wherein the wireless management frame comprises a critical update flag set to a value indicating a critical update.

7. The method of claim 6 further comprising:
incrementing a BSS Parameters Change Count; and wherein the wireless management frame further comprises the incremented BSS parameters change count.

8. The method of claim 1 wherein the wireless management frame further comprises data indicating one or more additional NPCA parameters.

9. The method of claim 8 wherein the one or more additional NPCA parameters comprise at least one of a set of NPCA disabled subchannels or a channel switch mode.

10. The method of claim 1 further comprising:
advertising within the BSS, by the access point, support for the NPCA mode of operation.

11. An access point comprising:
one or more memories; and
one or more processors communicatively coupled to the one or more memories, wherein the one or more processors are configured to, individually or collectively, perform operations comprising:
managing, by the access point, a basic service set (BSS) on a primary channel;
supporting, by the access point, a Non-Primary Channel Access (NPCA) mode of operation for the BSS using a first NPCA primary channel;
advertising, by the access point, the first NPCA primary channel to one or more wireless stations of the BSS;
accessing a determination of a NPCA primary channel change time for updating the BSS from the first NPCA primary channel to a second NPCA primary channel;
prior to the NPCA primary channel change time, transmitting by the access point, a wireless management frame that announces a NPCA primary channel change, the wireless management frame including data indicating the second NPCA primary channel and the NPCA primary channel change time; and
at the NPCA primary channel change time, transitioning, by the access point, the NPCA mode of operation for the BSS to use the second NPCA primary channel.

12. The access point of claim 11 wherein the data indicating the NPCA primary channel change time is a number of target beacon transmission times until the NPCA primary channel change time.

13. The access point of claim 11, the operations further comprising:
determining to switch from the first NPCA primary channel to the second NPCA primary channel based on detected interference on the first NPCA primary channel.

14. The access point of claim 11 wherein the wireless management frame is a beacon frame, a probe response frame or a (re)association response frame.

15. The access point of claim 11, the operations further comprising:
transmitting, after the NPCA primary channel change time, one or more additional management frames including data indicating the second NPCA primary channel.

16. The access point of claim 11 wherein the wireless management frame comprises a critical update flag set to a value indicating a critical update.

17. The access point of claim 16, the operations further comprising:
incrementing a BSS Parameters Change Count; and wherein the wireless management frame further comprises the incremented BSS parameters change count.

18. The access point of claim 11 wherein the wireless management frame further comprises data indicating one or more additional NPCA parameters.

19. The access point of claim 18 wherein the one or more additional NPCA parameters comprise at least one of a set of NPCA disabled subchannels or a channel switch mode.

20. The access point of claim 11, the operations further comprising:
advertising within the BSS, by the access point, support for the NPCA mode of operation.

21. A non-transitory computer readable storage medium comprising instructions that when executed configure one or more processors of an access point (AP) to perform operations comprising:
managing, by the AP, a basic service set (BSS) on a primary channel;
supporting, by the AP, a Non-Primary Channel Access (NPCA) mode of operation for the BSS using a first NPCA primary channel;
advertising, by the AP, the first NPCA primary channel to one or more wireless stations of the BSS;
accessing a determination of a NPCA primary channel change time for updating the BSS from the first NPCA primary channel to a second NPCA primary channel;
prior to the NPCA primary channel change time, transmitting by the AP, a wireless management frame that announces a NPCA primary channel change, the wireless management frame including data indicating the second NPCA primary channel and the NPCA primary channel change time; and
at the NPCA primary channel change time, transitioning, by the AP, the NPCA mode of operation for the BSS to use the second NPCA primary channel.
